(19) United States
(12) Patent Application Publication
(10) Pub. No.: US 2026/0036678 A1
(43) Pub. Date: Feb. 5, 2026

(54) High resolution LiDAR system with LCoS panel

(71) Applicant: CELLCUBES CO., LTD., Yongin-si (KR)

(72) Inventor: Deuk Soo JANG, Seongnam-si (KR)

(21) Appl. No.: 19/358,382

(22) Filed: Oct. 14, 2025

Related U.S. Application Data
(63) Continuation of application No. PCT/KR2023/095018, filed on Apr. 20, 2023.

(51) Int. Cl. G01S 7/481; G01S 17/89; G01S 17/931

(52) U.S. Cl. CPC G01S 7/4815; G01S 7/4816; G01S 17/89; G01S 17/931

(57) ABSTRACT

Provided is a high-resolution light detection and ranging (LiDAR) system using liquid crystal on silicon (LCoS). At this time, the high-resolution LiDAR system using the LCoS includes: a light source part configured to generate a plurality of pieces of light to perform a read inspection of a limit of a resolution of a target object at a level of millimeters by generating micron-sized pattern light; an LCoS part configured to pattern light having been emitted from the light source part into structured light; one or more target objects present within a field of view of a light source to allow light having been reflected by the LCOS part to be reflected on the one or more target objects; and a light detection part configured to detect information of the light reflected by the one or more target objects and convert the light information into an image signal.

### FIELD OF THE INVENTION

The present disclosure relates to a high-resolution light detection and ranging (LiDAR) system using liquid crystal on silicon (LCoS), and more particularly, to a LiDAR system capable of performing a read inspection of a limit of a resolution of a target object at a level of millimeters by generating micron-sized pattern light by employing various light sources in a form of structured light using an LCoS panel.

### BACKGROUND ART

Light detection and ranging (LiDAR) is an advanced device configured to emit light from a light source such as a laser or the like, and when the light is reflected back from a surrounding target object, receive the reflected light to measure a distance, a shape, or the like with respect to the target object to thereby precisely draw surroundings.

Currently, the LiDAR is used in an advanced driver assistance system (ADAS). In (a) of FIG. 5, a vehicle using the ADAS includes sensors equipped in front, rear, left, and right directions of the vehicle to perform a method of scanning surroundings of the vehicle using the LiDAR, has lasers arranged in a single or array configuration, and employs infrared (IR) light to create a detected image. Thus, the vehicle may perceive surrounding situations or obstacles while traveling.

At this time, since the LiDAR uses a single light source and a single sensor, the LiDAR performs forward scanning with a single piece of light and detection using the sensor in a detector unit, which takes a lot of time and worsens accuracy.

Therefore, this LiDAR may be used to simply check a distance, but it is difficult to determine a situation of a target object. In addition, even though a light source and a sensor may be configured in an array form to reduce scanning time, a reading resolution of the sensor is limited to only several millimeters due to sizes of the light source and the sensor. Thus, there are many limitations in applications in which accuracy is needed. That is, a driver may only detect an object and an environment of a vehicle and measure a distance between vehicles in real time using a radar sensor mounted on a front of the vehicle to maintain an appropriate distance between the vehicles. As such, as shown in (b) of FIG. 5, although images and surrounding environments such as trees and buildings may be determined, since an object resolution is extremely insufficient, it is very difficult to distinguish small objects near a road.

Additionally, a light source used in the LiDAR is laser light, and mainly employs a vertical-cavity surface-emitting laser (VCSEL) in a form of a To-can type or 1×N/M×N structure array. This light source is configured in a single or structured light form.

A mechanical-type LiDAR has difficulty in accurate detection in mobile devices where vibrations may occur in an operating environment, and there is a limitation in practical use of the mechanical-type LiDAR due to a limited lifespan of a motor. In addition, since the light source has a large size of hundreds of microns, delicate images may not be perceived. Thus, the mechanical-type LiDAR may not be used in applications in which high speed and high accuracy are needed. There is also a limitation in that the LiDAR used in robots needs a response speed of 240 frames per second or more and a resolution of several tens of microns. As such, since laser light is scanned using a motor or an array-type light source is used, stability issues may not be resolved due to a structural vibration problem in a mechanical type and insufficient accuracy during use in a transported body, it may be difficult to address stability issues.

Accordingly, when mounted on various mobile devices such as automobiles, motorcycles, drones, robots, airplanes, ships, submarines, cranes, armored vehicles, and tanks, the LiDAR faces many limitations in sensing surrounding obstacles and targets to determine situations. Particularly, the LiDAR is inadequate to be used in indoor robots, machine vision equipment, or medical applications.

Accordingly, the inventor of the present disclosure has applies, to other fields, and further developed the prior arts disclosed in Korean Patent Application No. 10-2021-003391 (Tomography microscope system of high resolution) and Korean Patent Application No. 10-2021-0037167 (Pollution measuring system with ultra-high resolution LCoS panel), and has come to propose a LiDAR system capable of distinguishing micron-sized obstacles or surrounding structures in the ADAS by securing high quality of general video images and providing a micron-level discriminating capability using the LCoS.

### DETAILED DESCRIPTION OF THE INVENTION

### Technical Problem

Accordingly, the present disclosure has been made in view of the above-mentioned problems occurring in the related art, and it is an object of the present disclosure to provide a high-resolution light detection and ranging (LiDAR) system capable of performing a read inspection of a limit of a resolution of a target object at a level of millimeters by generating micron-sized pattern light by employing various light sources in a form of structured light using a liquid crystal on silicon (LCoS) panel.

### Technical Solution

To accomplish the above-mentioned objects, according to one aspect of the present disclosure, there are provided a light source part 10 configured to generate a plurality of pieces of light; an LCoS part 20 configured to pattern light having been emitted from the light source part 10 into structured light; one or more target objects 30 present within a field of view of a light source to allow light having been reflected by the LCOS part 20 to be reflected on the one or more target objects 30; and a light detection part 40 configured to detect information of the light reflected by the one or more target objects 30 and convert the light information into an image signal.

At this time, the light source part is made of a light-emitting diode (LED) or a laser as an infrared/red (R)/green (G)/blue (B)/ultraviolet light source and configured in an array form of various combinations.

In addition, the arranged light sources are turned on individually or simultaneously through a switch, and used as a scanning source by applying wavelength variations through time division according to time at which the arranged light sources are turned on.

In addition, a light source is selected according to a color of a sample subject, and an on-time interval is further segmented to create an image through a combination of brightness and chroma.

Meanwhile, the light source part performs detection at a sampling rate of 400 Hz/second or more.

In addition, the LCOS modulator unit 30 generates a hologram (computer generated hologram (CGH)) pattern by creating a diffraction grating pattern using a composite wavelength of ultraviolet (UV), red (R), green (G), blue (B), and infrared (IR) light.

In addition, the LCoS part 20 minimizes a pixel size of a panel to be 7000 pixels per inch (PPI) or more

In addition, a sensor being used is a photo sensor capable of sensing UV, R, G, B, and IR light.

In addition, a pixel of the LCoS has a quadrilateral shape.

In addition, the LCOS part 20 uses a spatial light modulator including an electrically controlled birefringence (ECB) mode using liquid crystals.

In addition, a photo sensor of the light detection part 40 includes one or more selected from a photo-multiplier, a charge-coupled device (CCD) image element, and a complementary metal oxide semiconductor (CMOS) image sensor.

In addition, the photo-multiplier is a device configured to multiply an optical signal based on a principle of stimulated emission, and multiplied light is detected through the CCD image element or the CMOS image sensor.

In addition, with respect to the photo sensor, a special wavelength sensor is separately manufactured and switched to a UV-dedicated sensor, an IR-dedicated sensor, or green/blue/red-dedicated sensors to detect only particular wavelengths.

In addition, one or more selected from a light source 100, an LCoS panel 200, and a detector part 400 are configured to have a circular shape.

### Effects of the Invention

According to the configuration and operations described above, in the present disclosure, patterned light of several microns in size may be created and used by utilizing a single light source or multiple light sources in a form of structured light using an LCOS chip to detect and implement a wavelength of light at a frequency of 240 Hz or higher. This detection speed is more than twice as fast as a display speed of 60 to 120 Hz for TV and phone screens, and have an effect of securing accurate image data from moving objects.

In addition, an ultra-high resolution and ultra-high speed LiDAR system may be implemented by increasing obstacle and environment recognition sensing required in autonomous vehicles, small transport robots, robot vacuum cleaners, drones, etc. from a current level of 50 PPI pixels per inch (PPI) to 5000 PPI or higher, and from a perception speed of 10 frame/sec (fps) to 240 frame/sec. Thus, this provides an excellent effect of capable of performing a read inspection with a resolution limit at a micrometer level.

Furthermore, by converting the light source into two or more light sources, a sensing speed may be increased by about three to ten times compared to a speed in the related art. Thus, data that has not been observable before may be quantitatively analyzed, thereby enabling applications in new fields and areas. Particularly, this may be applied to mobility applications, robots, machine vision equipment, and micro-sensing areas that need high resolution, and may also be applied to 360-degree sensing devices and a medical field to provide new forms of image information for inspection, diagnosis, and analysis. Object analysis on a moving body may be performed by perception at high speed to acquire three-dimensional image data, and thus, may be utilized in vehicles, airplanes, missiles, ships, submarines, tanks, etc.

Through a circular structure in an embodiment of the present disclosure, 360-degree surround LiDAR sensing may be applied to vehicles and aircrafts to allow upper and lower three-dimensional detection of surroundings with a small number of sensors. Since a wavelength of light at a frequency of 400 Hz or higher may be implemented, rapid movements may be implemented, diagnosis and rapid response according to structural changes may be performed by observing high-speed movement.

### BRIEF DESCRIPTION OF THE DRAWINGS

FIG. 1 is a basic conceptual diagram of a light detection and ranging (LiDAR) system for a vehicle to which the present disclosure is applied.

FIG. 2 is a schematic block diagram of the LiDAR system according to the present disclosure.

FIG. 3 is a schematic block diagram of the LiDAR system having a circular structure according to an embodiment of the present disclosure.

FIG. 4 is a liquid crystal on silicon (LCoS) panel used in the present disclosure.

FIG. 5 illustrates an advanced driver assistance systems (ADASs) using a current LiDAR and a three-dimensional video image.

### MODE FOR THE INVENTION

The accompanying drawings are provided to convey the spirit of the present disclosure to a person of ordinary skill in the art, and for the sake of clear understanding, the core components are described, and descriptions of well-known functions and components that may unnecessarily obscure the gist of the present disclosure are omitted.

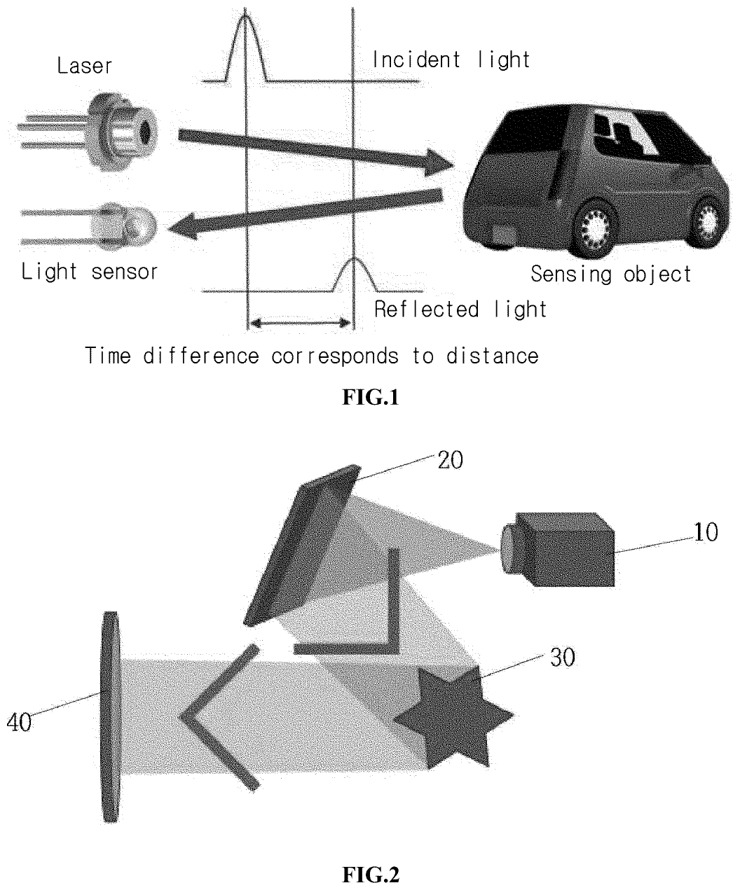

FIG. 1 shows a basic principle of a light detection and ranging (LiDAR) system for a vehicle to which the present disclosure is applied.

When light is scanned from a light source (laser) and emitted onto a target object (vehicle), the light is transformed due to physical phenomena such as scattering, reflection, and diffraction, and then, converted into image data in space-time through a sensor. Then, the image data is analyzed by a judgment algorithm of a servo system for object perception and judgment and utilized as valid data. At this time, a LiDAR system in the related art employs a single light source and a single sensor to perform forward scanning with a single piece of light and detection using the sensor in a detector unit, which takes a lot of time and worsens accuracy. Thus, the present disclosure is to implement a high-resolution real-time imaging system capable of visualizing three-dimensional images of an object by using a plurality of light sources and various modified light sources in multiple wavelength regions.

The LIDAR system according to the present disclosure is described with reference to FIG. 2.

The system in the present disclosure is configured to include a light source part 10, an LCoS part 20, a target object 30, and a detector part 40, and implements a high-resolution real-time image.

The light source part 10 is configured to generate and emit a composite beam by combining at least one selected from ultraviolet light, visible light (blue, green, and red), and infrared light. Ultraviolet light is short-wavelength light emitted from ultra-high-pressure mercury or halogen, and may achieve a resolution of up to 0.1 μm. In a near-infrared (IR) region ranging from 700 to 2500 nm, samples are analyzed, and since absorption due to a combination band of fundamental molecular vibrational energies such as —CH, —NH, and —OH originating from the IR region and first to fourth overtone bands is utilized, high sensitivity and high resolution may be secured. Attempts are made to L-band IR wavelengths, which have lower frequencies than those of C-band IR wavelengths. In a visible light region, projected light is divided into light of red (R), green (G), and blue (B) wavelengths.

To obtain light of the wavelengths described above, a high-brightness light-emitting diode (LED) or laser may be used as a light source. Under control by a light source controller (not shown), at least one piece of light among ultraviolet light, visible light (blue, green, and red), and infrared light is combined in a wavelength range to generate and emit a composite beam with an adjusted frequency. The light source controller is configured to emit a beam at a preset reference frequency, and an output terminal of the light source part has a structure of emitting the composite beam onto the LCoS part 20.

A composite beam emitter may be configured such that UV, red (R), green (G), blue (B), and IR light sources are configured in a form of LEDs or laser diodes, arranged in an array form, and turned on individually or simultaneously through a switch so that multiple sources are scanned into a prism and used as a scanning source. At this time, a wavelength may be changed according to time at which a light source is turned on. Thus, when five light sources are present, analysis of the samples may be differentiated in 2⁵, i.e., 64 steps, and when ten light sources are present, analysis of the samples may be differentiated in 1024 steps, thereby improving accuracy of the analysis. An emitter device is a very simple device, has a lifespan of 20,000 hours guaranteed as a laser light source, and is configured as a module kit for easy replacement. In addition, light source information obtained through composite light sources of various wavelengths and a large amount of image three-dimensional (3D) information are converted into big data to provide many standards and reliability for reading, inspection, and analysis of the samples, thereby realizing quantitative specificity.

The LCOS part 20 is configured to pattern light emitted from the light source part 10 into structured light.

LCOS (liquid Crystal on Silicon) has excellent phase modulation performance using a diffraction phenomenon among characteristics of light. The LCOS uses a capability of recording phase information of light in a form of an interference pattern and varying an amplitude or the phase information of the light depending on positions to implement an image.

An array of an LCoS panel creates a diffraction grating pattern to generate a hologram (computer generated hologram (CGH)) pattern. In holography, a digital micro mirror (DMD) of an amplitude modulation type and an LCoS spatial light modulator of a phase modulation type may be used.

The present disclosure provides a method of increasing a resolution by directly controlling and adjusting a phase of light using an LCOS scheme. At this time, the LCoS spatial light modulator of a phase modulation type is used, and an electrically controlled birefringence (ECB) mode using liquid crystals is mainly used. In the ECB mode, when no voltage is applied, the liquid crystals are aligned parallel to an electrode surface. However, when a voltage equal to or greater than a threshold voltage (Vth) is applied, the liquid crystals are tilted in a direction of an electric field. Thus, a phase of light changes due to refractive index anisotropy characteristics of the liquid crystals.

An LCOS substrate may be driven analogously or digitally. In a case of a digitally driven substrate, gray scales are represented using a pulse width modulation (PWM) method, raising concerns about phase stability. On the other hand, since an analogously driven substrate directly controls a liquid crystal phase, a phase may be stably represented for each gray scale. Thus, it is desirable to use the analogously driven substrate.

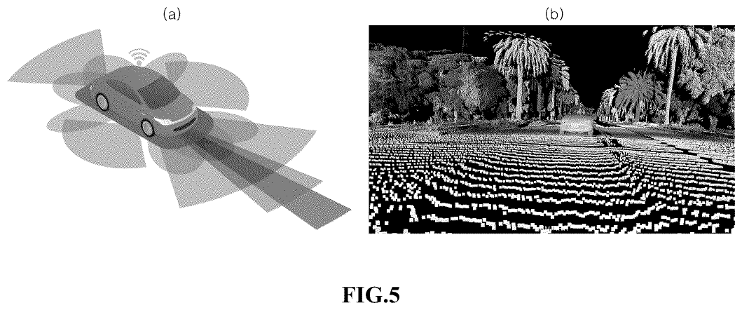

(a) in FIG. 4 shows an LCoS implemented in the present disclosure. The LCOS receives light into a blue region through a pixel array to create a desired pattern, and perform as a scan projection system functioning as a light source having wavelength analysis characteristics. to perform as a scanning projection system which functions as a light source with wavelength analysis characteristics. An active pixel array may be modified depending on a subject sample size and a shape of a lens, and it is desirable to manufacture the active pixel array to have a square shape.

(b) in FIG. 4 shows a product in which a gray region is an array region including 1984×1144 pixels. This product is applicable to small subjects. is suitable for being conveniently mounted on a mobile device for use, and is also convenient for application to small robots or aircraft. A LiDAR having a small structure is suitable for being manufactured and conveniently mounted on a mobile device for use, and is also conveniently applied to small robots or aircraft.

In the present disclosure, a pixel is a minimum unit in which a phase of light may be directly adjusted and controlled, and a resolution varies depending on a number of pixels constituting a panel. With advancements in display technology, a 4K (UHD) resolution display on the market has about 8 million pixels in a case of a TV. 4K has 4,096 pixels horizontally, which is four times a resolution defined by the digital cinema initiatives (DCI). To achieve a fine resolution to be implemented in the present disclosure, a unit size of pixels and a pixel size of a photo sensor need to be small, and a pixel size of the LCOS panel needs to be minimized to be 7000 pixels per Inch (PPI) or more. A sensor used at this time is a photo sensor capable of sensing UV, R, G, B, and IR light, which is different from a general charge-coupled device (CCD) or contact image sensor (CIS) (complementary metal oxide semiconductor (CMOS) Image sensor).

In FIG. 2, the target object 30 which is a subject refers to an object capable of performing reflection as one or more target objects within a field of view of a light source in the present disclosure. There are no restrictions on a size, shape, or material of the object, and the object may include an extremely small object with a special purpose, oil, or a stack structure of black ice to be read. When the system in the present disclosure is applied to a moving object such as a vehicle, components of a transport surface of transport objects may be analyzed and used as data on driving conditions.

In FIG. 2, the light detection part 40 is configured to detect information about light reflected by the target object 30 and convert the light information into an image signal.

Light emitted from the light source part 10 in the present disclosure is incident on the target object 30 through the LCOS part 20, and when the light undergoes diffraction, interference, refraction, and scattering, pattern information of wavelengths of the light is converted into image data by the light detection part 40 to generate various images, and then, the various images are transmitted to a signal processing unit.

A photo sensor provided in the light detection part 40 includes one or more selected from a photo-multiplier, a charge-coupled device (CCD) image element, and a complementary metal oxide semiconductor (CMOS) image sensor. The photo-multiplier is a device configured to multiply an optical signal based on a principle of stimulated emission, and multiplied light is detected through the charge-coupled device (CCD) image element or the CMOS image sensor.

Since an optical filter is intended to transmit only a desired wavelength, a desired wavelength may be cut into a partial region depending on an application to edit images in a form of editing wavelengths. Additionally, a special wavelength sensor may be separately manufactured and switched to be used as a UV-dedicated sensor, an IR-dedicated sensor, or green/blue/red-dedicated sensors to detect only particular wavelengths.

An image implementation part (not shown) is a device configured to process an image data signal detected by the light detection part 40 to generate a three-dimensional tomography image of a subject, and output the generated three-dimensional tomography image as a three-dimensional image. Data generated at this time is used as a source for ADAS and used as information needed for traveling. In a configuration for lighting, a wide variety of structured light may be realized without having to perform mechanical adjustments generally performed through lenses, prisms, filters, etc.

A color of illumination light may be controlled via an image signal. Different colors may be generated simultaneously at several points on a display, and different brightness levels of LiDAR illumination light may be implemented at several points.

An image of the target object 30 may be viewed through a general display device or simultaneously recorded in a storage device. A formatted image is used as reference data for reading and analysis and may be applied to various diagnoses, tests, and analyses. When acquiring a digitized image, a magnification varies depending on a scanning range. Therefore, to enhance resolution performance, an additional lens may be designed by taking into account a horizontal/vertical pixel size in the image and a field of view (FOV).

As described above, in the present disclosure, various modified light is emitted from a plurality of light sources and wavelength regions by the light source part 10, the light emitted from the light source part 10 is collimated and incident on the LCoS part 20 and reflected by the target object 30, and the reflected light is diffracted, interfered, refracted, and scattered. Then, pattern information of wavelengths of the light is converted into image data by the detector 40 to process various generated images. Thus, the generated various images are processed to visualize a three-dimensional image, thereby realizing a viewable high-resolution real-time image. That is, light may be converted using one light source or multiple light sources, and then, the converted light may be diffracted and reflected by a diffraction grating generator through the LCOS, and then, patterned. Then, the patterned light may be projected onto a subject, and the projected light may be diffracted, interfered, refracted, and scattered, and wavelengths of the diffracted, interfered, refracted, and scattered light may be converted into image data through a photo sensor. The image data may be stored, and then, converted into visible light and displayed through image processing techniques, or raw data may be stored and used as a source convertible into a new format, thereby being applicable in a wide variety of fields.

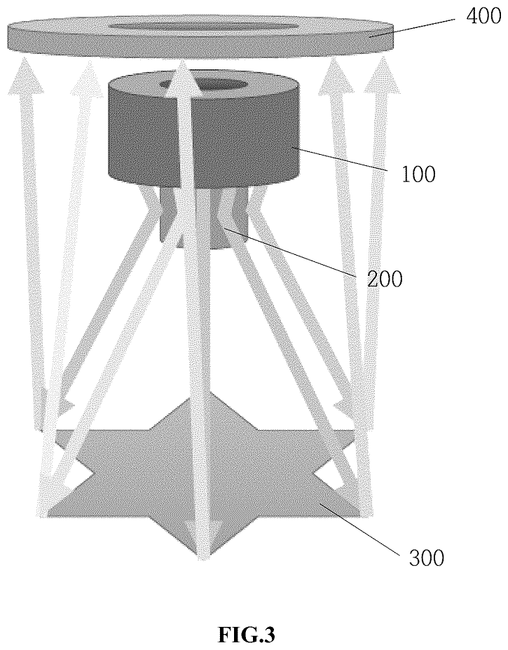

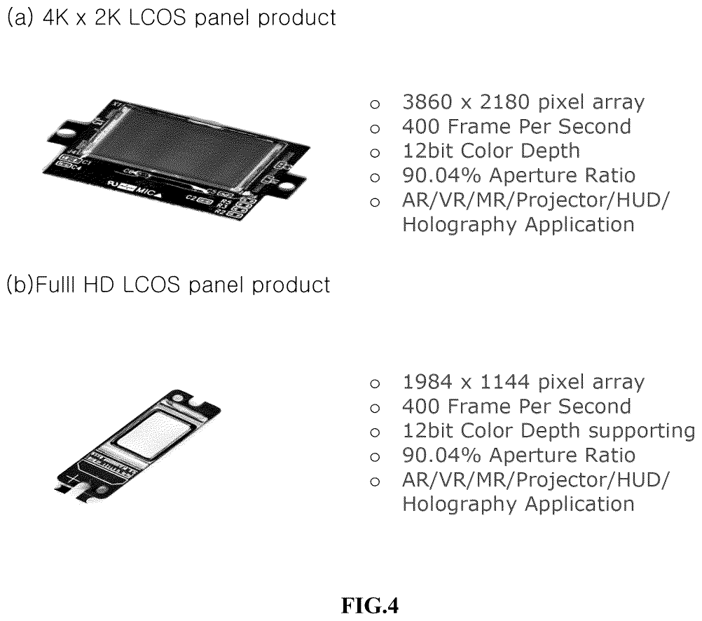

FIG. 3 illustrates still another embodiment of the LiDAR system according to the present disclosure.

In FIG. 3, the LiDAR system having a circular structure is implemented. A light source 100 having a circular structure is provided to have a light source capable of performing emission in all directions at 360 degrees, and an LCoS panel 200 is also configured to have a circular structure to scan a pattern of structured light in all directions. The scanned light is reflected by a target object 300, and a sensed image obtained by using time differences between first, second, and third orders of the light source is converted into depth image data using pattern information of wavelengths of diffracted, interfered, refracted, and scattered light by the detector part 400 having a circular structure. Thus, a high-resolution real-time image is implemented to allow a three-dimensional image to be viewable.

Here, with respect to the light source 100, the LCOS panel 200, and the detector part 400 each having a circular structure, it is not needed to configure all structures in a circular form. These components may be configured as a structure that automatically scans 360 degrees by using a motor to cover 360 degrees or as a structure in which several LiDARs in a quadrilateral arrangement are combined with each other. The light source 100 having a circular structure has a circular connection type of prism, and the detector part 400 having a circular structure may be configured by arranging sensor chips in a circular band shape to increase a sensing speed.

Accordingly, when the LiDAR system having a circular structure and implemented as an embodiment in FIG. 3 is used as a LiDAR capable of providing object and spatial perception capabilities in drones or transport robots, the LiDAR system may be manufactured as a thin structure for spatial object perception in small spaces. In particular, this is an optimized configuration for a LiDAR used to determine and collect information regarding surrounding obstacles and structural perception in small enclosed spaces or factories. This configuration may secure a lot of information using a small structure, and thus, may be applied to transport devices and mobility within such spaces.

In addition, in a sensing method using a general LiDAR, after laser light is generated and emitted as point light or an array of light, the laser light is reflected from an object. Then, the reflected laser light is detected, and a shape or a structure of the object is analyzed in two dimensions (2D) or three dimensions (3D) to be utilized as data. This method is performed mainly by emitting a light from a light source on an object and performing scanning. In this method, a rotational type using a motor or a light array is switched according to sections (timing) so that a reflected image is perceived by a sensor to obtain desired image data.

1. A high-resolution light detection and ranging (LiDAR) system using liquid crystal on silicon (LCoS), the high-resolution LiDAR system comprising:
a light source part configured to generate a plurality of pieces of light by creating a composite beam using light sources arranged by combining a plurality of pieces of light selected from ultraviolet (UV) light, visible light including blue (B) light, green (G) light, and red (R) light, and infrared (IR) light, and selecting a light source according to a color of a sample subject and further segmenting an on-time interval to create an image through a combination of brightness and chroma;
an LCoS part configured to pattern light having been emitted from the light source part 10 into structured light;
one or more target objects present within a field of view of a light source to allow light having been reflected on the LCOS part to be reflected by the one or more target objects 30; and
a light detection part configured to detect information of the light reflected by the one or more target objects and convert the light information into an image signal.

2. The high-resolution LiDAR system of claim 1, wherein the arranged light sources are turned on individually or simultaneously through a switch, and used as a scanning source by applying wavelength variations through time division according to time at which the arranged light sources are turned on.

3. The high-resolution LiDAR system of claim 1, wherein the light source part performs detection at a sampling rate of 400 Hz/second or more.

4. The high-resolution LiDAR system of claim 1, wherein the LCOS modulator unit 30 generates a computer generated hologram (CGH) pattern by creating a diffraction grating pattern using a composite wavelength of the UV light, the R light, the G light, the B light, and the IR light.

5. The high-resolution LiDAR system of claim 4, wherein the LCoS part minimizes a pixel size of a panel to be 7000 pixels per inch (PPI) or more.

6. The high-resolution LiDAR system of claim 4, wherein a sensor being used is a photo sensor capable of sensing the UV, R, G, B, and IR lights.

7. The high-resolution LiDAR system of claim 4, wherein a pixel of the LCOS part has a quadrilateral shape.

8. The high-resolution LiDAR system of claim 4, wherein the LCoS part uses a spatial light modulator comprising an electrically controlled birefringence (ECB) mode using liquid crystals.

9. The high-resolution LiDAR system of claim 1, wherein a photo sensor of the light detection part comprises one or more selected from a photo-multiplier, a charge-coupled device (CCD) image element, and a complementary metal oxide semiconductor (CMOS) image sensor.

10. The high-resolution LiDAR system of claim 9, wherein the photo-multiplier is a device configured to multiply an optical signal based on a principle of stimulated emission, and multiplied light is detected through the CCD image element or the CMOS image sensor.

11. The high-resolution LiDAR system of claim 9, wherein with respect to the photo sensor, a special wavelength sensor is separately manufactured and switched to a UV-dedicated sensor, an IR-dedicated sensor, or green/blue/red-dedicated sensors to detect only particular wavelengths.

12. The high-resolution LiDAR system of claim 1, wherein one or more selected from a light source, an LCOS panel, and a detector part are configured to have a circular shape.
